(19) United States
(12) Patent Application Publication
(10) Pub. No.: US 2011/0041614 A1
(43) Pub. Date: Feb. 24, 2011

(54) Circuit for a micromechanical structure-borne sound sensor and method for operating a micromechanical structure-borne sound sensor

(76) Inventors: Holger Wolfmayr, Eningen (DE); Fouad Bennini, Reutlingen (DE); Thomas Mayer, Pfullingen (DE); Andreas Wienss, Reutlingen (DE)

Correspondence Address: KENYON & KENYON LLP, ONE BROADWAY, NEW YORK, NY, 10004, US

(21) Appl. No.: 12/744,864

(22) PCT Filed: Sep. 30, 2008
(86) PCT No.: PCT/EP08/63051

§ 371 Date: Nov. 12, 2010

(30) Foreign Application Priority Data
Nov. 28, 2007 (DE) 10 2007 057 136.6

(51) Int. Cl. G01H 11/06

(52) U.S. Cl. 73/654

(57) ABSTRACT

A circuit for a micromechanical structure-borne sound sensor and a method for operating this sensor, a voltage generator being used to apply voltages to at least one micromechanical element for recording the structure-borne sound, so that a change in the micromechanical element occurs. In addition, an evaluation circuit is provided, which records the at least one electrically recordable parameter of micromechanical element at a sampling rate and analyzes the same. This at least one parameter changes in response to the change. A clock-pulse generator is also provided for generating the sampling rate and for generating the clock pulse. A frequency generator is used for generating the clock pulse at least intermittently for the test operation, the frequency generator producing the clock pulse as a multiple or as a submultiple of the sampling rate.

### FIELD OF THE INVENTION

The present invention relates to a circuit for a micromechanical structure-borne sound sensor, respectively to a method for operating a micromechanical structure-borne sound sensor.

### BACKGROUND INFORMATION

German Patent Application DE 10 2004 029 078 A1 discusses a semiconductor acceleration sensor and testing the same using a mechanical shaker. The German Patent Application DE 101 48 858 A1 discusses a micromechanical sensor having a self-test function, in which case, a seismic mass of the micromechanical sensor is moved in response to an applied voltage in order to perform the self-test.

### SUMMARY OF THE INVENTION

In contrast, the advantage of the circuit according to the present invention for a micromechanical structure-borne sound sensor and of the method according to the present invention for operating such a micromechanical structure-borne sound sensor having the features of the independent claims is that the need for a mechanical shake testing in the sensitive frequency region (>1 kHz) may be eliminated, and the high-frequency test signal is generated in a circuit of the micromechanical structure-borne sound sensor itself. In particular, a test in the field may, therefore, be performed on a long-term, continuous basis. Thus, it is possible to adapt to changes in the operating parameters of the structure-borne sound sensor during operation. The circuit according to the present invention, respectively the method according to the present invention are, therefore, simpler and more cost-effective than those known from the related art. Moreover, by using a frequency generator to provide the clock pulse at least intermittently for the test operation, the approach in accordance with the present invention offers widely varying options for applying frequencies to the structure-borne sound sensor in order to more precisely analyze its characteristic response thereto. In the present context, “at least intermittently” means that the clock pulse is not necessarily provided by the frequency generator during the entire test operation; there may also be periods of time when it is provided by the clock-pulse generator.

The circuit according to the present invention for the micromechanical structure-borne sound sensors uses a voltage generator to apply voltages to a micromechanical element used for sensing the structure-borne sound. This voltage application induces a change in the micromechanical element, consequently, a movement of micromechanical structures, which is then manifested in a change in the electrically measurable parameters. These parameters are recorded by an evaluation circuit, processed at a sampling rate, and ultimately analyzed. The sampling rate is provided by a clock-pulse generator, and the clock pulse used for applying the voltages to the micromechanical element is likewise generated by the clock-pulse generator, but, during test operation, at least intermittently by the frequency generator, the frequency generator producing the clock pulse as a multiple or as a submultiple of the sampling rate. It is thus possible to generate a corresponding test signal for the structure-borne sound sensor without having to provide separate test inputs and while maintaining the sampling rate both in normal, as well as in test operation.

For example, the clock-pulse generator provides the sampling rate as a submultiple of the system clock in normal operation and in test operation. The clock pulse of the clock-pulse generator is also used in normal operation and in test operation to control the voltages for the measurement phase. In this example, the frequency generator only controls the second phase of the voltage generator: this is the case in normal operation, due to the fact that a no-test voltage is applied, which may correspond to the frequency generator being switched off. In test operation, the test voltage is applied in accordance with the set frequency. It is, thus, possible to apply frequencies to the structure-borne sound sensor that represent a submultiple of the sampling rate.

In particular, by using the frequency generator, it is possible to evaluate the system's response characteristic at various frequencies, without having to provide a mechanical excitation. By using the same sampling rate of the evaluation circuit in test operation and in normal operation, an identical transfer function is obtained in both operating modes.

In the present case, the term “circuit” is understood to be an integrated circuit, a plurality of integrated circuits, and/or a combination of integrated and discrete components, or a circuit of only discrete components. Parts of the circuit may also be provided as software modules.

A micromechanical structure-borne sound sensor is understood to be an acceleration sensor that includes a micromechanically produced sensing element. However, in the case of this sensor, the output signal is not low-pass filtered, as the low-pass filtered signal is the acceleration signal that is used, for example, for passenger protection systems or vehicle-dynamics control systems. In structure-borne sound sensor systems, the structure-borne sound is of interest. It resides above the critical frequency of the low pass that is customary for acceleration sensors, for example at 1-2 kHz. For this, the structure-borne sound signal is then band-pass filtered. The structure-borne sound sensor may be configured within and/or outside of a control unit. The structure-borne sound sensor is understood to not only be the micromechanical element, but also the electronics that are described in accordance with the present invention. Ultimately, these also include an arrangement for transmitting the data, thus, for example, a transmitter module, which, for example, transmits the data via current modulation to a control unit or to a processor, for example, a microcontroller.

The voltage generator is a circuit which generates the voltages for influencing the micromechanical element and to which the micromechanical element is, therefore, connected. For this purpose, the voltage generator has a suitable arrangement for generating these voltages. The voltages are generally derived from the supply voltage and may be generated by voltage-stabilization circuits. The supply voltage may also be directly used as a test voltage, for example. In particular, it is possible to use the value 0V directly, while all other voltage values are derived.

Part of the voltage generator may be provided as software, for example, in order to drive a corresponding arrangement to vary the amplitude of the voltage. However, this may also be implemented as hardware.

The micromechanical element is a membrane or a finger structure, for example, which moves under the influence of the stresses, respectively an external vibration or acceleration, and thereby alters electrically recordable parameters of the micromechanical element.

The evaluation circuit may also be a circuit or a circuit element, one portion also being realizable as software. The evaluation circuit is connected to the micromechanical element in a way that allows it to detect at least one electrically recordable parameter, such as a capacitance value. Resistance values or other parameters may also be acquired in this manner. The evaluation circuit samples these parameters using a sampling rate that is the same for the test operation and for the normal operation. Evaluation is understood in the present case to be providing the value, or already a determination, for example, a transfer curve of the structure-borne sound sensor.

A clock-pulse generator is understood to be a circuit element, which, for example, derives an additional clock pulse from the system clock, and which, in the present case, specifies the sampling rate and the basic clock pulse of the voltage generator for all operating modes. The clock-pulse generator may also be implemented as a counter or as a different circuit. The clock-pulse generator may also have its own oscillator from whose oscillations, the clock pulse is derived.

The frequency generator provides the clock pulse for the test operation, this clock pulse being a multiple or a submultiple of the sampling rate. The frequency generator may also be partially implemented as software.

Normal operation is understood to be the measuring operation, while the test operation features the self-test of the structure-borne sound sensor. This is particularly true for field use.

The measures and further developments delineated in the dependent claims render possible advantageous improvements to the circuit, indicated in the independent claims, for a micromechanical structure-borne sound sensor and the method according to the present invention for operating a micromechanical structure-borne sound sensor.

It is advantageous that the frequency generator is programmable with respect to the clock pulse. This programming may be implemented, in particular, via a serial digital interface, which may be via what is generally referred to as an SPI interface. It is possible to also provide other interfaces, for example, bidirectional current interfaces employing Manchester encoding.

The programming makes it possible to scan different frequencies in test operation in order to obtain more precise information about the performance characteristics of the structure-borne sound sensor. In particular, a transfer function may be thereby determined. An SPI interface is a serial peripheral interface, in which a plurality of lines are used in parallel, for example, a line from the master to a slave, another line from the slave back to the master, lines for chip select and for the clock pulse. Chip select makes it possible to activate the individual chip that is to be addressed by the master or that is to transmit information to the master.

It is also provided that, during normal operation, the voltage generator be configured to generate voltages in each clock cycle, for the portion of the clock cycle duration, in order to prevent a movement of the at least one micromechanical element. In this context, the same potential may be applied, for example, to each electrode of the micromechanical element, so that an unwanted movement is thereby prevented. In this context, the micromechanical element has three connections, for example, two connections having fixed electrodes and one center electrode being movable. For the other portion of the clock cycle duration, the measuring operation is provided because the required voltages are then applied to the sensor electrodes. These voltage may also vary over time as a function of the evaluation concept.

It is advantageous to select the voltages for the measuring operation in a way that will enable an unwanted deflection of the micromechanical element to be avoided in this case as well. Thus, care must be taken to ensure that the same potential results on each electrode, on the average over time.

It is also advantageous that the frequency generator is designed as a counter, in particular, as a digital counter. The system clock or, alternatively, a derived clock pulse may be directly used as a clock pulse for the counter. When the counter has reached the set value, thus the bits for adjusting the frequency, it is reset to zero. The algebraic sign of the voltages applied to the fixed electrodes is changed at every reset. This results in the high-frequency excitation of the sensor, as described above. However, besides influencing the counter status, other influencing methods are possible, such as varying the voltage. In test operation, the frequency may be adjusted as a function of the number of deflection pulses, respectively the deflection direction, realized by the counter or by a change in the algebraic sign. Other types of modulation are also possible, such as a pulse length variation and/or an amplitude variation, for example.

On the basis of the evaluation of the at least one parameter, the evaluation circuit may advantageously adjust the structure-borne sound sensor during test operation. What is meant by test operation is precisely the testing of the structure-borne sound sensor, while normal operation connotes the measuring operation of the structure-borne sound sensor. These adjustment values are then stored either in the sensor or in a control unit and thus may be used for processing the measured values of the structure-borne sound sensor. In this context, a sensitivity adjustment is carried out on the basis of the evaluation of the parameters. Test signal excitations may be carried out both at a low frequency, as well as at a high frequency, low-frequency excitations being below 1-2 kHz and high-frequency excitations above the same. At high frequencies, the test signals lead to the determination of the sensitivity in the high frequency region.

With the aid of the various self-test frequencies, the sensitivity of the sensor may advantageously be tested in the structure-borne sound region relative to the low-frequency sensitivity. Thus, by adjusting the sensor in the low-frequency region (as in the case of existing acceleration sensors) and by likewise considering the ratio of the high-frequency to the low-frequency test signal, it is possible to adjust the high-frequency sensitivity without having to mechanically stimulate the sensor in this region.

It is possible that the multi-frequency self-test and, very advantageously in the present case, the ratio of the high-frequency to the low-frequency test signal not only permit an adjustment, but also allow a subsequent verification of the sensitivity. Thus, for example, at every start-up, it is possible to ascertain changes in the sensor element, such as a spring rupture, or variations in the attenuation, which, in turn, may be induced by a change in the gas composition or in the pressure prevailing in the micromechanical sensor.

It is also advantageous that the evaluation circuit performs a an air-tightness test on the structure-borne sound sensor as a function of the at least one parameter. A hermetic encapsulation of the sensor element is fundamentally important to the functionality of acceleration sensors and thus to the structure-borne sound sensors. This ensures, inter alia, that gas that is entrapped at a specific internal pressure is not able to escape. The entrapped gas directly influences the sensor properties in that it determines the attenuation and thus the resonance frequency of the movable micromechanical structures. In addition, a hermetic encapsulation is important for protecting the sensitive micromechanical components from environmental influences, such as moisture, for example. The hermetic encapsulation is made possible by a cap wafer, which is adhesively bonded to the sensor wafer by seal glass. The seal glass is pressed onto the sensor wafer, around each micromechanical structure, so that the intention is that each sensor element be impervious following the separation. In the present case, the imperviousness is ascertained, for example, in that both a high-frequency excitation of the micromechanical element, as well as a low-frequency excitation of the micromechanical element take place. This low-frequency output signal is sensitive to the process control, however, not to the attenuation and thus not to the internal pressure. Accordingly, the individual ratio of the high-frequency to the low-frequency output signal renders possible a still clearer separation of impermeable to permeable sensors. This test is possible when final measurements are taken and for all conditions in which it is possible to ensure a defined temperature. As a general principle, this procedure is also applicable for different temperatures, and thus for different sensor applications in the field. The test is completely implemented in an integrated circuit, for example, a corresponding error flag being activatable.

It is also advantageous that the clock pulse sequentially assumes different values during test operation, in order to thereby ascertain a transfer function of the structure-borne sound sensor. Thus, a scanning of the frequency is meant, for example, in order to ascertain a most precise possible transfer function of the structure-borne sound sensor as a function of the frequency.

Exemplary embodiments of the present invention are illustrated in the drawing and are explained in greater detail in the following description.

### BRIEF DESCRIPTION OF THE DRAWINGS

FIG. 1 shows a block diagram of an occupant safety system in a vehicle.

FIG. 2 shows an evaluation path of a structure-borne sound sensor.

FIG. 3 shows a block diagram of a structure-borne sound sensor.

FIG. 4 shows another block diagram of a structure-borne sound sensor.

FIG. 5 shows the normal operation in accordance with the present invention.

FIG. 6 shows the test operation according to the present invention.

FIG. 7 shows a transfer function of the structure-borne sound sensor.

FIG. 8 shows a possible distribution of impermeable to permeable sensors as a function of a high-frequency excitation.

FIG. 9 shows a corresponding distribution of the sensors as a function of the ratio of high-frequency to a low-frequency excitation.

FIG. 10 shows a flow chart of the method according to the present invention.

### DETAILED DESCRIPTION

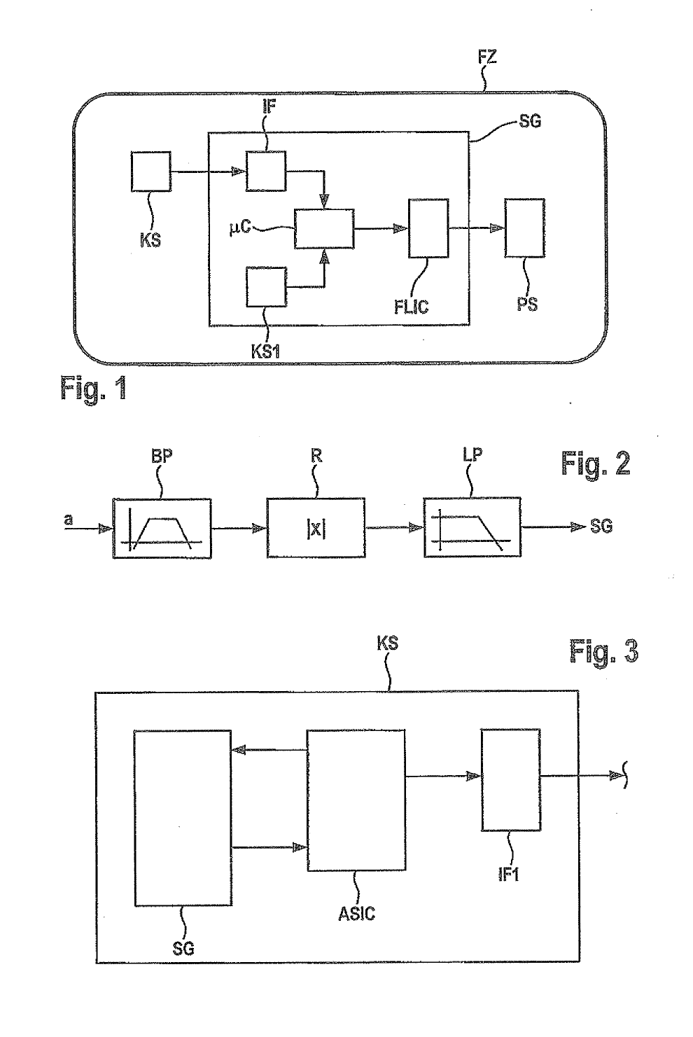

FIG. 1 shows a block diagram of an occupant safety system; in the present case, only those parts of fundamental importance to the exemplary embodiments and/or exemplary embodiments of the present invention being discussed, and only these parts being represented. Other parts necessary for operating the occupant safety system have been omitted for the sake of simplicity. A control unit SG for controlling occupant safety devices, such as airbags or belt pretensioners, are provided in vehicle FZ. A structure-borne sound sensor system KS, which is located outside of control unit SG, communicates with control unit SG via an interface IF A structure-borne sound sensor system KS1 is provided within control unit SG. It is possible that the structure-borne sound sensor system is configured within and/or outside of control unit SG. Other crash sensors have been omitted for the sake of simplicity, as have other electronic components of the control unit, such as memory devices, additional interfaces, a parallel hardware triggering path, energy reserve, etc. Both interface IF, as well as structure-borne sound sensor system KS1 are connected to microcontroller μC, which processes the signals of structure-borne sound sensor system KS and of structure-borne sound sensor system KS1 in a control algorithm for occupant safety devices. As a function of the thereby obtained result, microcontroller μC controls a control circuit FLIC, which features power switches, whose closing signifies an activation of occupant safety devices PS.

Structure-borne sound sensor system KS, KS1 generates comprehensive information, that is also available at a very early stage, concerning a collision event and thereby renders possible a precise and reliable control of occupant safety devices PS. The structure-borne sound sensor system is particularly suited for subjecting other crash signals to plausibility checking. Acceleration signals, air pressure signals and also surrounding-field signals count among such signals.

However, the structure-borne sound sensor system may also be used for other technical fields of application.

FIG. 2 shows an evaluation path of structure-borne sound sensor KS. Acceleration a is initially transmitted from micromechanical element to a bandpass BP which blocks low-frequency accelerations. A rectifier R and a low-pass filter LP then follow, which analyze the sound intensity. The micromechanical element is a part of the signal-processing chain and, therefore, participates via its PT2 low-pass characteristics in the overall transfer function.

FIG. 3 shows another block diagram of structure-borne sound sensor KS. Micromechanical sensor element SE is connected via signal input and outputs to circuit ASIC in accordance with the exemplary embodiments and/or exemplary embodiments of the present invention. Sensor element SE provides the at least one parameter, for example the capacitance, and is conditioned by the ASIC with respect to the voltages for the normal and/or test operation. The ASIC may also undertake a digitization of the measurement data, which are then transmitted via interface IF1 to control unit SG. The transmission may be undertaken by a current modulation, a power-line data transmission being used, for example. Adjustment data may also be stored in a memory device at structure-borne sound sensor KS, it being possible for the memory device to be part of circuit ASIC or for it to be an external memory device.

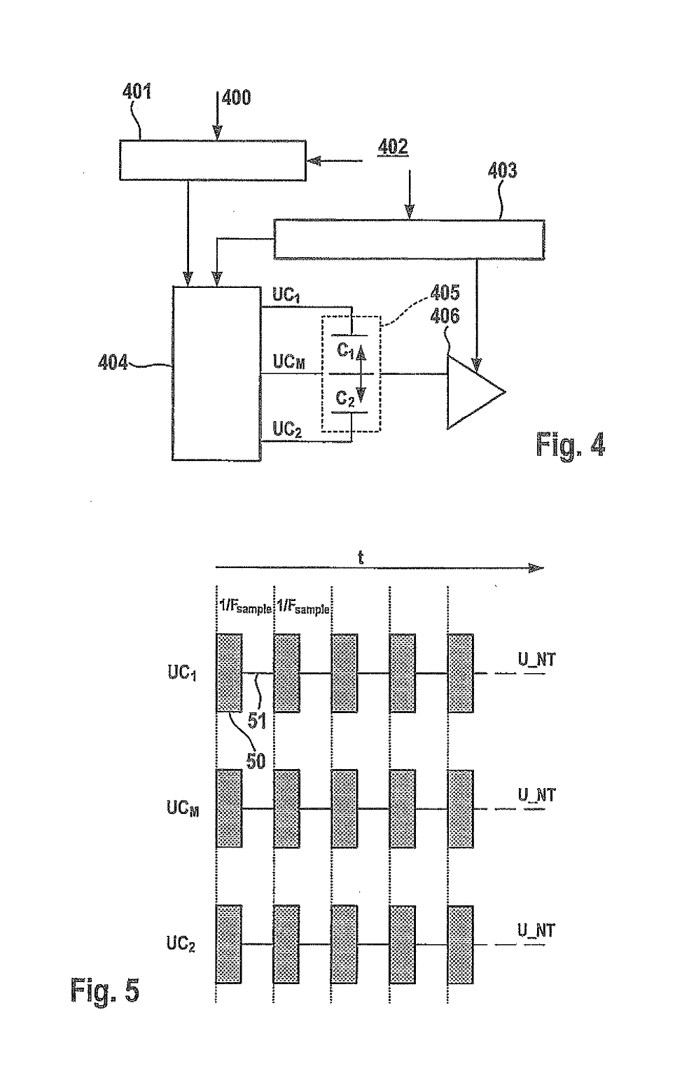

In another block diagram, FIG. 4 shows the design of structure-borne sound sensor with respect to the ASIC and the sensor element. Illustrated here are only those parts of the ASIC that are essential to the exemplary embodiments and/or exemplary embodiments of the present invention. The ASIC may feature other circuit elements. Instead of the ASIC, a microprocessor having corresponding interfaces may also be used, for example. Other processor types are also possible; a discrete design is also possible.

In the present case, micromechanical element 405 is characterized by outer electrodes C1 and C2, which are fixed, and by center electrode CM. Center electrode CM is able to move relative to outer electrodes (C1 and C2), so that the capacitances between the center electrode and the respective outer electrodes vary in the process. This movement of center electrode CM may arise due to applied decelerations, sound signals or also applied voltages. Corresponding bias voltages may also be provided for the measuring operation. These voltages UC1, UCM and UC2 are generated by voltage generator 404. The voltage generator generates the voltages, which are also adjustable in terms of amplitude, in a predefined clock pulse, and thereby applies voltages UC1, UCM, UC2 to individual electrodes C1, CM and C2. The clock pulse is provided either by clock-pulse generator 403 or by frequency generator 401. Clock-pulse generator 403 derives the clock pulse, for example, from system clock 402, or it has its own oscillator circuits for generating the clock pulse.

Frequency generator 401 likewise uses system clock 402, but is controlled via interface 400, which is designed, for example, as an SPI interface, by a data command as to which frequency and which clock pulse it is to transmit to voltage generator 404.

In accordance with the exemplary embodiments and/or exemplary embodiments of the present invention, the clock pulse provided by frequency generator 401 is a submultiple or a multiple of the clock pulse that clock-pulse generator 403 provides. A logic device, which in normal operation uses the clock pulse of clock-pulse generator 403 and, in test operation, the clock pulse of frequency generator 401, decides which clock pulse is used. This logic device is localized, for example, in voltage generator 404.

During adjustment, the SPI command is transmitted by the test machine; the SPI command arrives later in the ready-for-operation control unit from microcontroller contained therein. It is also conceivable that the ASIC implements and also evaluates various tests without an external SPI command, for example, in order to realize an expanded self-test. However, this would then require that the precise sequence be defined and permanently encoded in the hardware.

At this point, voltage generator 404 applies voltages UC1, UCM and UC2 to micromechanical element 405 and thereby implements a change in capacitances C1 and C2. These capacitances are recorded by evaluation circuit 406 at a sampling rate provided by clock-pulse generator 403, and ultimately analyzed. The evaluation may also simply be in the form of providing the parameter. It is possible that more than one parameter is recorded.

In a signal time diagram, FIG. 5 shows the normal operation that the circuit according to the present invention makes possible. Voltages UC1, UCM and UC2 are shown. Gray portions 50 represent the measurement of the structure-borne sound signal, while what is generally referred to as the no-test voltage UNT is applied in section 51, and a movement of center electrode CN relative to outer electrodes C1 and C2 is thereby prevented. This occurs for all voltages UC1, UCM and UC2.

In order for the test operation to be useful as a sensitivity adjustment, it must be ensured that the system behaves in the test operation as identically as possible to the normal operation. For this reason, the clock scheme is modified in normal operation in a way that allows a test operation that does not require changing the sampling rate. For this purpose, a portion, for example, 50% of each clock cycle is used in order to apply a no-test voltage to all electrodes. For the no-test voltage, a voltage is selected that is already present in the system, for example the reference potential of the evaluation circuit, in many systems half of the supply voltage, in order to make an effective realization possible. Since all electrodes have the same potential, the sensor element is not deflected.

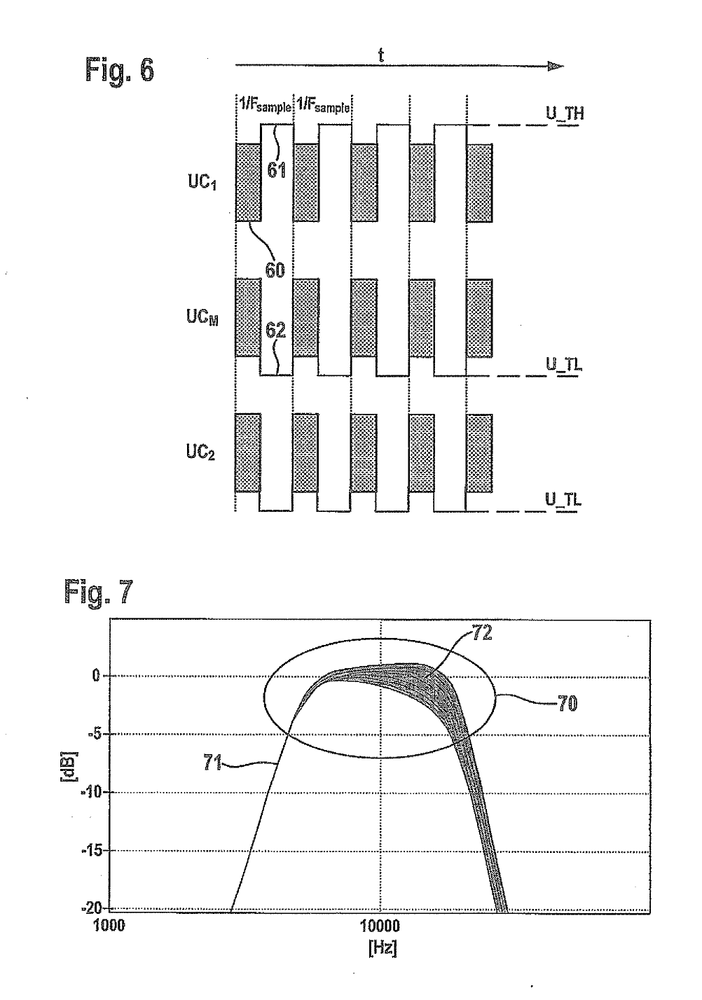

At this point, FIG. 6 shows the test operation; voltages UC1, UCM and UC2 being shown, in turn. In section 60, a normal measurement is performed, while, in sections 61 and 62, the corresponding test voltages are applied to the electrodes. By exchanging the voltages at UC1 and UC2, a deflection in the other direction may again be realized.

As described above, the circuit has been expanded by one frequency generator, in order to realize a high-frequency test signal. For the sensitivity adjustment of a specific frequency, it suffices to have a frequency generator for one single frequency, for example 10 kHz. To also be able to test the transfer function of the sensor, the frequency generator is designed to be programmable. The programming is carried out via the digital interface of the ASIC, in our case, via an SPI interface.

The configuration makes it possible to produce any desired test frequencies as submultiples of the sampling frequency. Example: At a sampling rate of 125 kHz, all frequencies having 125 kHz may be represented by 2*N. In this context, N is a whole number where N>1.

FIG. 7 shows a transfer function 71, the curve shapes being represented for 50 cases, in combination with the band pass. These sensors are statistically adjusted to the same sensitivity. From the variance in pass-band range 72, characterized by 70, it is discernible that an adjustment does not suffice at low frequency to minimize the variance of the transfer function in the band-pass range of the sensor. The reason for this is the attenuation of the mechanical system, that does not have any influence on the statistical sensitivity, but does on the sensitivity in the band-pass range.

In the case of the sensitivity adjustment provided, the assumption at this point is that, given a high frequency, the relation of the sensitivity to the low-frequency, respectively to the static is subject to the same proportionality, as is the high-frequency to the low-frequency, respectively static i.e., to the low-frequency test signal. This was confirmed by investigations.

In response to the application of a test signal to the sensor element, the seismic mass of the sensor element is deflected by the electrostatic force. As already explained, a change in capacitance follows, which is converted by the ASIC into a virtually proportional output signal. Accordingly, a periodic test signal produces a periodic output signal, that may be further evaluated in the ASIC. For this, the evaluation electronics must provide a high-pass or a bandpass as a signal path that contains the excited frequency, as well as an effective value generator and a low-pass. A simply evaluable direct-voltage signal U_HF is then present at the end of the signal path. In accordance with the frequency of the input signal and the transfer function of the acceleration sensor, including the ASIC, the amount of U_HF changes as a function of the frequency. This is shown in FIG. 7. As mentioned, this transfer function is verifiable by employing the multi-frequency self-test at certain interpolation points (submultiples of the sampling frequency), that may be used both for the sensitivity adjustment at these frequencies, as well as for a subsequent verification of the sensitivity.

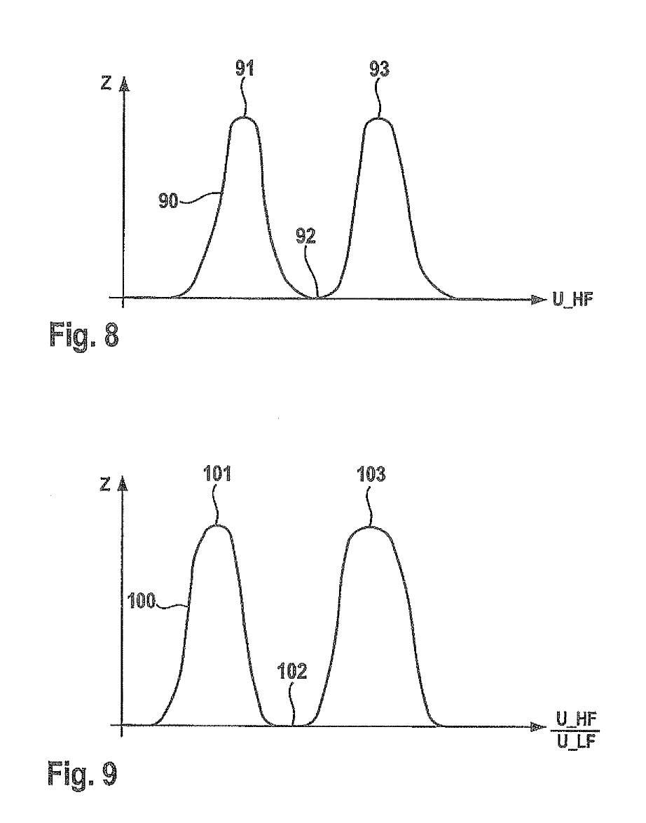

The attenuation plays a significant role, particularly in the proximity of the resonance frequency of the sensor element. For example, if the intention is to check whether the attenuation has changed, it is particularly advantageous to select a test frequency near the resonance frequency of the sensor. However, the high-frequency test signal is not determined exclusively by the attenuation, but also by process variances, which makes it difficult to have a clear separation of different attenuation properties (resulting, for example, from different gas compositions). This is illustrated in FIG. 8. Curve 90 is the distribution of various sensors as a function of voltage U_H F. Sensors 91 are impermeable when sensors 93 are permeable. The boundary resides at 92, there being an overlap region in this case.

To assess the attenuation even more effectively, it is provided to additionally consider the output voltage of a low-frequency excitation. The low-frequency test signal may be evaluated via the standard low-pass channel, for example 400 Hz, that is currently included in all acceleration sensors. This low-frequency output signal is sensitive to the process control, however, not to the attenuation. Accordingly, the individual ratio of high-frequency to low-frequency output signal U_HF with respect to U_LF permits an even clearer separation of attenuation properties, induced, for example, by an altered gas composition. This is illustrated in FIG. 9. Curve 100 shows, in turn, the distribution of the sensors having gas composition 1 101 and 2 103. Separation 102 is well-defined and does not indicate any overlap region.

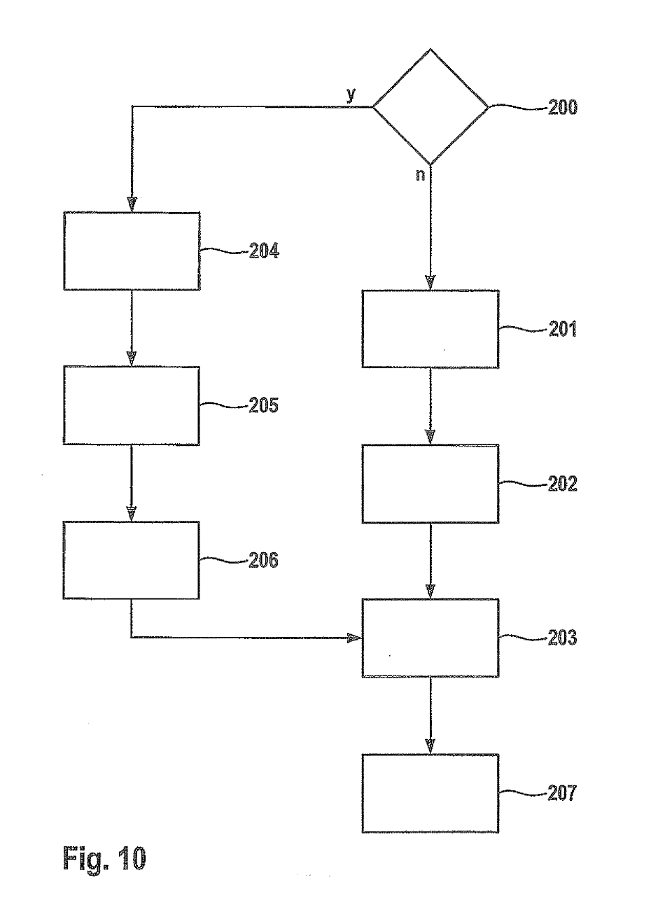

FIG. 10 shows a flow diagram of the method according to the present invention. In method step 200, it is checked whether a test operation or a normal operation is taking place. If a test operation is being carried out, the system jumps to method step 204; at this point, the frequency generator generates the clock pulse for the voltage generator, for example, via programming. The sampling rate is provided in method step 205 by the clock-pulse generator, as is also the case in normal operation. In method step 206, voltages at the electrodes are applied to the micromechanical element. The parameters, which reveal the changes in the microstructure, are then evaluated in method step 203.

If it is ascertained in method step 200 that no test operation, but rather that a normal operation is being carried out, then the clock pulse and the sampling rate are provided by the clock-pulse generator in method step 201. In method step 202, measurement voltages are applied, respectively, the no-test voltage is applied using a portion of the clock pulse, to the micromechanical element, in order to prevent a movement of the center electrode relative to the fixed outer electrodes. The measured values are evaluated in method step 203. In method step 207 there then follows the adjustment or tests for the test operation, and in normal operation the measurement, which is then evaluated, for example, in a triggering algorithm for occupant safety devices.

1-10. (canceled)

11. A circuit for a micromechanical structure-borne sound sensor, comprising:
a voltage generator to apply voltages in a clock pulse to at least one micromechanical element for recording the structure-borne sound, so that a change occurs in the micromechanical element;
an evaluation circuit to record and analyze at least one electrically recordable parameter of the micromechanical element at a sampling rate, the at least one parameter changing in response to the change;
a clock-pulse generator to generate the sampling rate and generate the clock pulse; and
a frequency generator to at least intermittently provide the clock pulse for a test operation, the frequency generator producing the clock pulse as a multiple or as a submultiple of the sampling rate.

12. The circuit of claim 11, wherein the frequency generator is programmable with respect to the clock pulse.

13. The circuit of claim 12, wherein a digital interface, which is an SPI interface, is provided for the programming.

14. The circuit of claim 11, wherein the voltage generator is configured to generate voltages that prevent a movement of the at least one micromechanical element during normal operation, in each clock cycle, for one portion of the clock cycle duration.

15. The circuit of claim 11, wherein the frequency generator is a counter.

16. The circuit of claim 15, wherein the voltages are influenced as a function of the counter status.

17. The circuit of claim 11, wherein the evaluation circuit adjusts the structure-borne sound sensor in a test operation as a function of the at least one parameter.

18. The circuit of claim 11, wherein at least one of a sensitivity and a gas-composition testing of the structure-borne sound sensor is carried out in test operation by the evaluation circuit as a function of the at least one parameter.

19. A method for operating a micromechanical structure-borne sound sensor, the method comprising:
applying voltages to at least one micromechanical element, which is used for recording the structure-borne sound, in one clock pulse, so that a change occurs in the micromechanical element;
recording and evaluating at least one electrically recordable parameter of the micromechanical element using a sampling rate, the at least one parameter changing in response to the change;
generating the sampling rate and the clock pulse by a clock-pulse generator, wherein the clock pulse for a test operation is generated at least intermittently by a frequency generator, and wherein the clock pulse is generated as a multiple or as a submultiple of the sampling rate.

20. The method of claim 19, wherein the clock pulse sequentially assumes different values during test operation, so as to ascertain a transfer function of the structure-borne sound sensor.
